(19) United States
(12) Patent Application Publication
(10) Pub. No.: US 2020/0379542 A1
(43) Pub. Date: Dec. 3, 2020

(54) BATTERY STATE WIRELESS DISPLAYING DEVICE AND METHOD

(71) Applicants: Inventec (Pudong) Technology Corporation, Shanghai (CN); INVENTEC CORPORATION, Taipei (TW)

(72) Inventors: Chun-Chi Lin, Taipei (TW); Ying-Shan Chen, Taipei (TW); Tong-Ting Wei, Taipei (TW)

(21) Appl. No.: 16/540,221

(22) Filed: Aug. 14, 2019

(30) Foreign Application Priority Data
May 29, 2019 (CN) 201910457668.1

(51) Int. Cl. G06F 1/3212; H02J 7/00; G06F 1/16

(52) U.S. Cl. CPC G06F 1/3212; H02J 7/0052; H02J 7/0029; H02J 2007/005; G06F 1/1613; H02J 2007/0049; H02J 7/0047

(57) ABSTRACT

A battery state wireless displaying method, which is adapted to an electronic device having a CPU comprises the following steps. A battery assembly transmits a battery data to a controller when the CPU is not in operation. The controller generates battery information according to the battery data. The controller sends the battery data to a software interface of a portable device via a wireless transmission assembly.

### CROSS-REFERENCE TO RELATED APPLICATIONS

This non-provisional application claims priority under 35 U.S.C. § 119(a) on Patent Application No(s). 201910457668.1 filed in China on May 29, 2019, the entire contents of which are hereby incorporated by reference.

### BACKGROUND

### 1. Technical Field

The disclosure relates to a battery state wireless displaying method, more particularly to the wireless displaying method for remotely showing the battery state of an electronic device even when the central processing unit of the electronic device is not in operation.

### 2. Related Art

Nowadays, the notebook has become a popular electronic product. Generally, the battery of the notebook is configured to a rechargeable battery, and the information such as the remained power, the charging time, etc., which are shown on the screen when the notebook is operating in the operation system (OS).

However, when the notebook has not entered the OS, the user can not directly get the information about the battery, and it is not convenient once the user needs to take the notebook out suddenly. Similarly, when the notebook is not in the OS and is charged currently, the user can not directly get the state of charge. Hence, the probability of the overcharge of the battery is much higher, and the battery may be damaged due to the overcharge. Additionally, it needs to enter particular command in the specific interface to get the health state of the battery for most of the notebooks, and aforementioned way is not institutive for the common users.

### SUMMARY

According to one or more embodiment of this disclosure, a battery state wireless displaying method which is adapted to an electronic device having a CPU comprises the following steps. A battery assembly transmits a battery data to a controller when the CPU is not in operation. The controller generates battery information according to the battery data. Furthermore, the controller sends the battery data to a software interface of a portable device via a wireless transmission assembly.

According to one or more embodiment of this disclosure, a battery state wireless displaying device adapted to an electronic device having a central processing unit, which comprises a battery assembly, a controller and a wireless transmission assembly. The battery assembly is adapted to generate a battery data when the central processing unit is not in the operation. The controller is adapted to be electrically connected to the battery assembly, with the controller receives the battery data from the battery assembly and generates battery information according to the battery data. Moreover, the wireless transmission assembly is adapted to be electrically connected to the controller, with the wireless transmission assembly receives the battery information from the controller, and the wireless transmission assembly is adapted to send the battery information to a software interface of a portable device.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1A is a block diagram of the battery state wireless displaying device in an embodiment of this disclosure.

FIG. 1B is a schematic diagram of the battery state wireless displaying device in an embodiment of this disclosure.

FIG. 2 is a flowchart of the battery state wireless displaying method in an embodiment of this disclosure.

FIG. 3 is a flowchart of the battery state wireless displaying method in another embodiment of this disclosure.

FIG. 4A is a block diagram of the battery state wireless displaying device in another embodiment of this disclosure.

FIG. 4B is a schematic diagram of the battery state wireless displaying device in another embodiment of this disclosure.

FIG. 5 is a flowchart of the battery state wireless displaying method in another embodiment of this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

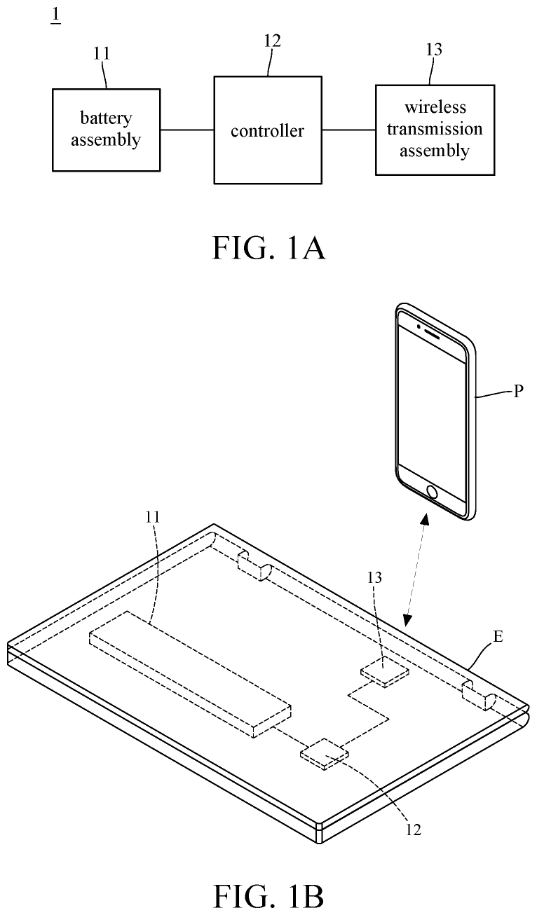

Please refer to FIG. 1A and FIG. 1B. FIG. 1A is a block diagram of the battery state wireless displaying device in an embodiment of this disclosure. FIG. 1B is a schematic diagram of the battery state wireless displaying device in an embodiment of this disclosure. A battery state wireless displaying device 1 adapted to an electronic device E having a central processing unit (CPU) comprises a battery assembly 11, a controller 12 and a wireless transmission assembly 13.

The battery assembly 11 is electrically connected to the controller 12, and the battery assembly 11 generates battery data when the CPU of the electronic device E is not in operation. Specifically, the battery assembly 11 comprises a battery and an integrated circuit (IC) which are electrically connected to each other, wherein the integrated circuit obtains the battery data from the battery, and the integrated circuit sends the battery data to the controller 12. For example, the integrated circuit may be a power management integrated circuit (PMIC), and the battery may be the rechargeable (or the secondary battery) battery such as the lead acid battery, the nickel hydrogen battery or the lithium ion battery, this disclosure is not limited thereto. On the other hand, aforementioned “the CPU not in the operation” means that the operating system (OS) of the electronic device E is not active, which indicates that the system power states (S-States) is in one of S1 (sleep state) through S5 (soft off state).

The controller 12 is electrically connected to the battery assembly 11, wherein the controller 12 receives the battery data from the battery assembly 11 and generates battery information according to the battery data. Specifically, the battery data may comprise the information of the battery assembly 11, such as original battery capacity, times of charging, current battery power, current voltage and charging electric current. Additionally, the battery information may comprise the current information of the battery assembly 11, such as the state of charges/discharges, total numbers of charges/discharges, current battery power during charging, or the remaining battery power, etc. It is worth to mention that, the battery information is able to be the data providing a plurality of functions through a software interface, such as generating a warning message for overcharge or the abnormal current as the battery assembly 11 is charging, estimating the usage time based on the remaining battery power of the battery assembly 11, and estimating the efficiency of charge and outputting the graph or table associated with the battery assembly 11. It needs to be noticed that, this disclosure is not limited thereto. In practice, the controller 12 may be implemented by an embedded controller 12 (EC), and the controller 12 is able to receive the battery data as the battery of the battery assembly 11 is keeping to be electrically connected to the controller 12.

The wireless transmission assembly 13 is electrically connected to the controller 12. The wireless transmission assembly 13 receives the battery information from the controller 12 and sends the battery information to the software interface of the portable device P, wherein the electric power of the wireless transmission assembly 13 is supplied by the battery assembly 11. In an embodiment, the wireless transmission assembly 13 is a Bluetooth low energy (BLE) transmission assembly, but other embodiments are not limited thereto. For example, the communication protocol of the wireless transmission assembly 13 also may be the Bluetooth or the wireless network. Specifically, the Bluetooth low energy is more efficient in power saving than the Bluetooth, and the process for communicatively connection to the electronic device E is simpler than the wireless network. For these reasons, the Bluetooth low energy may be preferable to be used in the device disclosed in this disclosure.

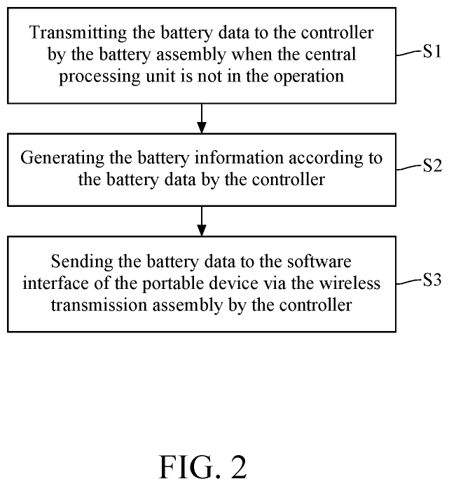

Please refer to FIG. 2. FIG. 2 is a flowchart of the battery state wireless displaying method in an embodiment of this disclosure. Please refer to the step S1: transmitting the battery data to the controller by the battery assembly when the central processing unit is not in the operation; wherein the battery data is the original data generated by the battery assembly directly. When the controller receives the battery data, please refer to the step S2: generating the battery information according to the battery data by the controller, wherein the battery information indicates more specific information about the battery assembly than the battery data. When the controller generates the battery information, please refer to the step S3: sending the battery data to the software interface of the portable device via the wireless transmission assembly by the controller, wherein the portable device may be a mobile phone or a tablet.

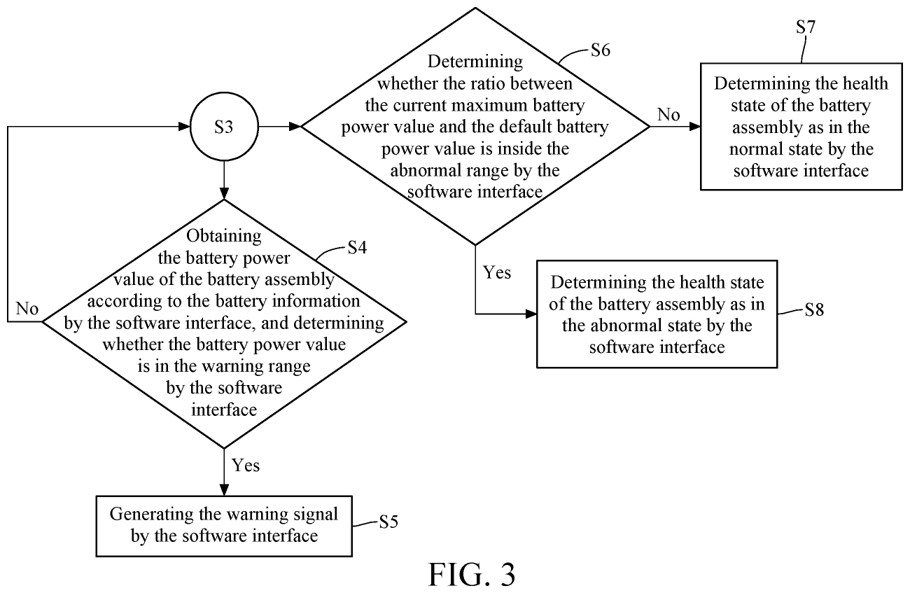

Please refer to FIG. 3. FIG. 3 is a flowchart of the battery state wireless displaying method in another embodiment of this disclosure. Please refer to the step S4 and S5 for descripting the warning process as the battery assembly is low battery power. Please refer to the step S4: obtaining the battery power value of the battery assembly according to the battery information by the software interface, and determining whether the battery power value is in the warning range by the software interface. Specifically, the software interface has a battery power threshold, and the battery power threshold may be set by the user of the portable device or the producer of the software interface. Furthermore, the software interface is able to determine whether the battery power value is in the warning range based on whether the battery power value is lower/lower or equal to the battery power threshold. When the software interface determines that the battery power value is in the warning range, please refer to the step S5: generating the warning signal by the software interface, wherein the warning signal may be performed with voice, vibration or message by the portable device. When the software interface determines that the battery power value is not in the warning range, then aforementioned process goes to the step S3 in FIG. 3.

Please refer to the step S6 to S8 for descripting how the software interface determines a health state of the battery assembly. Please refer to the step S6: determining whether the ratio between the current maximum battery power value and the default battery power value is inside the abnormal range by the software interface, wherein the current maximum battery power value and the default battery power value may be obtained by the software interface according to the battery information. When the software interface determines the ratio is outside the abnormal range, please refer to the step S7: determining the health state of the battery assembly as in the normal state by the software interface; wherein the normal state indicates the battery assembly is able to work and supply electric power in a proper way. When the software interface determines that the ratio is in the abnormal range, please refer to the step S8: determining the health state of the battery assembly as in the abnormal state by the software interface. Since the abnormal state indicates the current maximum battery power value of the battery assembly is too low, the software interface can generate aforementioned warning signal to prompting the user to replace the battery.

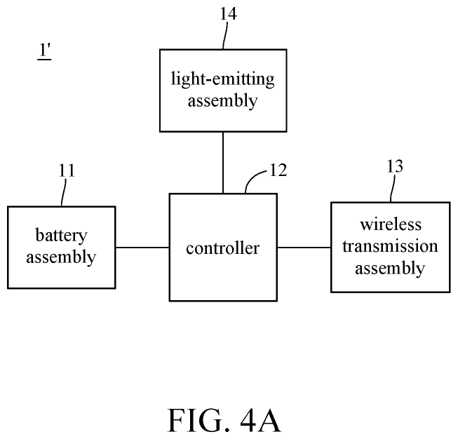

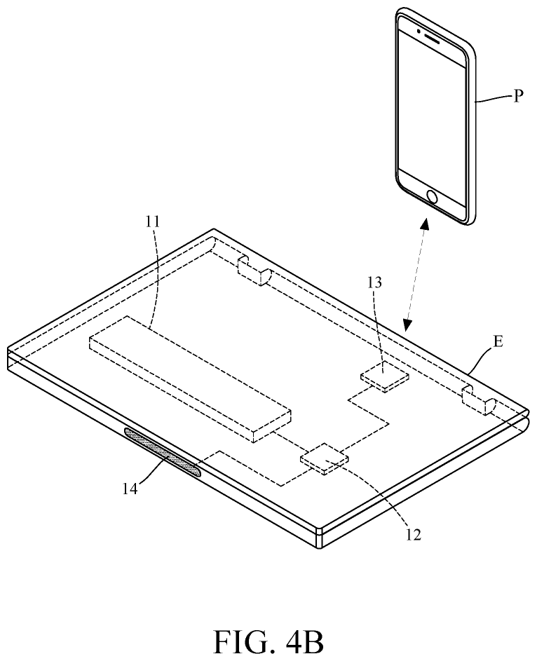

Please refer to FIG. 4A and FIG. 4B. FIG. 4A is a block diagram of the battery state wireless displaying device in another embodiment of this disclosure. FIG. 4B is the schematic diagram of the battery state wireless displaying device shown in FIG. 4A. The battery state wireless displaying device 1′ further comprises a light-emitting assembly 14.

The light-emitting assembly 14 is electrically connected to the controller 12, wherein the light-emitting assembly 14 generates light when receives the battery information from the controller 12. Moreover, the light-emitting assembly 14 changes an optical characteristic of the light when receives a control signal from the controller 12, wherein the control signal is generated after the controller 12 is triggered by the software interface.

Specifically, after the controller 12 generates the battery information according to the battery data, the light-emitting assembly 14 is able to generate the light according to the battery information at least, and the light-emitting assembly 14 displays the battery information based on the optical characteristics corresponding to different situations. For example, as the battery information is the current battery power value, the controller 12 is able to control the light-emitting assembly 14 to generate red light (indicating low battery power) or yellow light (indicating normal battery power) according to different current battery power values. Hence, the battery assembly 11 is able to show different current battery power values through generating the light with different optical characteristics.

In another embodiment, after the controller 12 sends the battery information to the light-emitting assembly 14, the software interface is able to trigger the controller 12 to send the control signal to the light-emitting assembly 14, wherein the control signal is associated with the optical characteristic of the light generated by the light-emitting assembly 14. Specifically, when the user adjusts the optical characteristic through the software interface, the software interface is able to trigger the controller 12 to send the control signal to the light-emitting assembly 14. For example, the control signal can change the yellow light indicating normal battery power to green light. Alternatively, as the red light indicating to low battery power is flashing, the control signal can change the flashing frequency of the red light. For these reasons, the user can adjust the optical characteristic of the light generated by the light-emitting assembly 14 through the software interface by themselves, and the variety of user experience can be provided.

Moreover, in practice, the light-emitting assembly 14 may comprise a microcontroller unit (MCU) and a plurality of lamps. Furthermore, the lamps may be the light-emitting diodes (LED) or the organic light-emitting diodes (OLED) etc., this disclosure is not limited thereto.

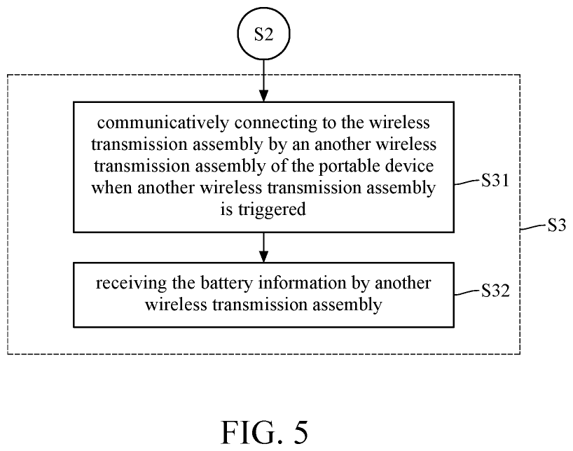

Please refer to FIG. 5. FIG. 5 is a flowchart of the battery state wireless displaying method in another embodiment of this disclosure. In this embodiment, the portable device has another wireless transmission assembly. Please refer to the step S31: communicatively connecting to the wireless transmission assembly by an another wireless transmission assembly of the portable device when another wireless transmission assembly is triggered, wherein the communication protocol of another wireless transmission assembly is the same as the wireless transmission assembly of the electronic device. When another wireless transmission assembly is communicatively connected to the wireless transmission assembly, please refer to the step S32: receiving the battery information by another wireless transmission assembly. For example, when the wireless transmission assembly is implemented by the Bluetooth low energy or the Bluetooth, the wireless transmission assembly of the electronic device keeps being communicatively connected to the portable device once the Bluetooth communication assembly of the portable device is triggered and started to search the Bluetooth communication assembly around. Also, the battery information keeps being sent to the software interface of the portable device as the electronic device is communicatively connected to the portable device. However, when the electronic device is not charged, the electric power of the wireless transmission assembly is supplied by the battery assembly. Hence, it causes unnecessary waste of the electric power of the battery assembly. As a result, the Bluetooth communication assembly of the portable device should be powered on when the user wants to know the battery information of the battery assembly. Furthermore, the wireless transmission assembly starts to be communicatively connected to the portable device as the Bluetooth communication assembly of the portable device is powered on, thereby the electric power of the battery assembly can be use more efficiently.

As a result, the battery state wireless displaying device and method disclosed in this disclosure, the battery information is able to be sent to the portable device through the wireless transmission assembly even when the electronic device is not in the operation in the OS, thereby the user can check the battery information quickly through the portable device.

The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A battery state wireless displaying method adapted to an electronic device having a central processing unit, comprising:
transmitting a battery data to a controller by a battery assembly when the central processing unit is not in operation;
generating battery information according to the battery data by the controller; and
sending the battery data to a software interface of a portable device via a wireless transmission assembly by the controller.

2. The wireless displaying method according to claim 1, wherein the wireless transmission assembly is a Bluetooth low energy transmission assembly.

3. The wireless displaying method according to claim 1, after generating the battery information according to the battery data by the controller, further comprising:
sending the battery information to a light-emitting assembly of the electronic device by the controller; and
generating light at least according to the battery information by the light-emitting assembly.

4. The wireless displaying method according to claim 3, after sending the battery information to the light-emitting assembly of the electronic device by the controller, further comprising:
triggering the controller to send a control signal to the light-emitting assembly by the software interface, wherein the control signal is associated with an optical characteristic of the light generated by the light-emitting assembly.

5. The wireless displaying method according to claim 1, wherein the software interface has a battery power threshold, after sending the battery data to the software interface of the portable device via the wireless transmission assembly by the controller, the method further comprises:
obtaining a battery power value of the battery assembly according to the battery information by the software interface, and determining whether the battery power value is in a warning range by the software interface; and
generating a warning signal by the software interface when the software interface determines the battery power value is in the warning range.

6. The wireless displaying method according to claim 1, after sending the battery data to the software interface of the portable device via the wireless transmission assembly by the controller, further comprising:
obtaining a current maximum battery power value of the battery assembly and a default battery power value of the battery assembly according to the battery information by the software interface, and determining whether a ratio between the current maximum battery power value and the default battery power value is in an abnormal range by the software interface;
determining a health state of the battery assembly as in a normal state by the software interface when the software interface determines the ratio is outside the abnormal range; and
determining the health state of the battery assembly as in an abnormal state by the software interface when the software interface determines the ratio is inside the abnormal range.

7. The wireless displaying method according to claim 1, wherein sending the battery data to the software interface of the portable device via the wireless transmission assembly by the controller comprises:
communicatively connecting to the wireless transmission assembly by an another wireless transmission assembly of the portable device when the another wireless transmission assembly is triggered; and
receiving the battery information by the another wireless transmission assembly.

8. A battery state wireless displaying device adapted to an electronic device having a central processing unit, comprising:
a battery assembly adapted to generate a battery data when the central processing unit is not in operation;
a controller adapted to be electrically connected to the battery assembly, with the controller receiving the battery data from the battery assembly and generating battery information according to the battery data; and
a wireless transmission assembly adapted to be electrically connected to the controller, with the wireless transmission assembly receiving the battery information from the controller, and the wireless transmission assembly adapted to send the battery information to a software interface of a portable device.

9. The battery state wireless displaying device according to claim 8, wherein the wireless transmission assembly is a Bluetooth low energy transmission assembly.

10. The battery state wireless displaying device according to claim 8, further comprising a light-emitting assembly adapted to be electrically connected to the controller, wherein the light-emitting assembly generates light when the light-emitting assembly receives the battery information from the controller, and the light-emitting assembly changes an optical characteristic of the light when the light-emitting assembly receives a control signal from the controller, wherein the control signal is generated by the controller after the controller is triggered by the software interface.
